(19) United States
(12) Patent Application Publication
(10) Pub. No.: US 2006/0108280 A1
(43) Pub. Date: May 25, 2006

(54) Filter media prepared in aqueous system including resin binder

(76) Inventor: Wijadi Jodi, Burnsville, MN (US)

Correspondence Address: MERCHANT & GOULD PC, P.O. BOX 2903, MINNEAPOLIS, MN, 55402-0903, US

(21) Appl. No.: 11/253,842

(22) Filed: Oct. 19, 2005

Related U.S. Application Data
(63) Continuation-in-part of application No. PCT/US04/10284, filed on Apr. 2, 2004.
(60) Provisional application No. 60/460,375, filed on Apr. 4, 2003.

(51) Int. Cl. B01D 39/02

(52) U.S. Cl. 210/505

(57) ABSTRACT

A media matrix for a separator, such as an air/oil separator, is described. The media matrix can be used as a coalescing stage, as a drain stage or both. In general the media matrix comprises a glass fiber media matrix having an aqueous based resin system. Preferably a binding agent is present, for example an inorganic binding agent such as alum. Methods of preparation are provided.

### CROSS-REFERENCE TO RELATED APPLICATIONS

The present application is a continuation-in-part of parent U.S. application ______ filed under Express main number EV 495841790 US on Sep. 30, 2005 entitled “Filter Media Prepared in Aqueous System Including Resin” with Jodi, Wijadi identified as the inventor. The referenced Sep. 30, 2005 application was a National Stage filing of PCT application PCT/US2004/010284, which was filed Apr. 2, 2004, with a claim of priority to U.S. provisional application Ser. No. 60/460,375, filed Apr. 4, 2003. Each of the identified filings is incorporated herein, by reference, in its entirety. A claim of priority to the parent U.S. application and the other filed applications, is made to the extent appropriate.

### FIELD OF THE INVENTION

The present invention relates to preparation of air/oil separator media, the resulting media, and its use. The filter media generally comprises glass fibers loaded into a three dimensional matrix, from an aqueous system. The disclosure concerns providing within the glass fibers a resin formulation as a binder.

### BACKGROUND OF THE INVENTION

The main purpose of this work is to replace a solvent carried resin saturation system with a water based resin system in air/oil separation media. The solvent carried resin system is basically a two part epoxy solution diluted in solvent such as acetone or alternatively, methyl isobutyl ketone. The two part epoxy is dissolved or diluted in the solvent to allow ease of penetration through the vacuum formed glass fiber media. The solvent is evaporated before the epoxy is heat cured. Elimination of solvent in the binder system is desired to prevent fire hazards from the flammable solvent vapors.

A prior art process is exhibited in FIG. 1. The fibers, to be used to generate the separator component of an air/oil separator, are dispersed in water and then applied to a mandrel 1, through which a vacuum draw is applied (vacuum forming). The mandrel 1, with the fiber media 2 loaded thereon, is then dried. The dried media 2 is removed from the mandrel, and an epoxy solution at 14 is applied to it. After solvent evaporation and cure, the dried, resin loaded, media results. It can then be assembled as a coalescer stage or drain stage, for use in an air/oil separator or similar construction.

### SUMMARY OF THE INVENTION

A media matrix for use in an air/oil separator is provided. The media matrix generally comprises a glass fiber media matrix having a resin system loaded therein, facilitated by a binding or flocculating agent. The preferred binding or flocculating agent is an inorganic binding agent, such as alum.

The media matrix can be used as a coalescing stage, a drain stage, or both, in a separator such as an air/oil separator.

Preferred methods of preparation and use are described.

Also provided is a preferred fiber matrix for a coalescing stage in an air/oil separator. The fiber matrix is preferably prepared with a resin, from an aqueous based system, therein. Preferred methods of providing the matrix are also provided.

### BRIEF DESCRIPTION OF DRAWINGS

FIG. 1 is a schematic depiction of a prior art solvent based saturation system.

FIG. 2 is a schematic depiction of a water based saturation system.

FIG. 3 is a schematic depiction of a beater addition aqueous system.

FIG. 4 is a top view of an air/oil separator including media according to the present disclosure.

FIG. 4a is a cross-sectional view taken along line 4a-4a, FIG. 4.

FIG. 4b is an enlarged, fragmentary view of a portion of FIG. 4a.

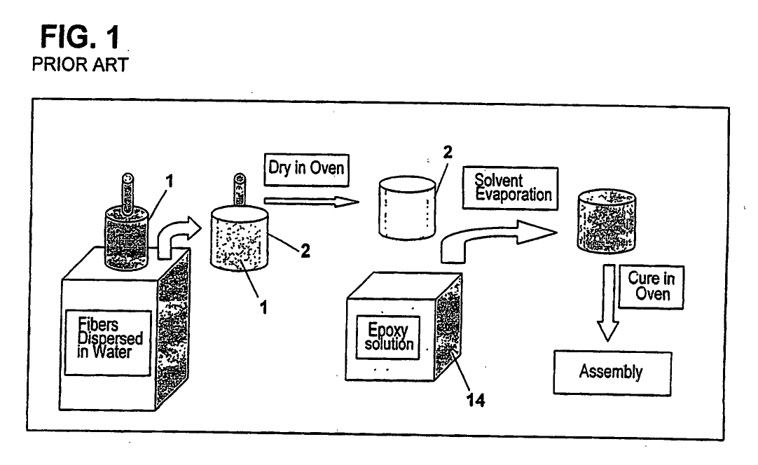

### DETAILED DESCRIPTION

A. General Processing Steps.

There are two methods of introducing water based binders into the air/oil separation media. One method is through saturation. Water based saturation involves dilution of the resin by water to allow the resin to penetrate the glass fiber medium. The benefit here is the elimination of flammable vapors and the elimination of a solvent evaporation stage. Since water is not flammable, it can be evaporated when the resin is heat cured.

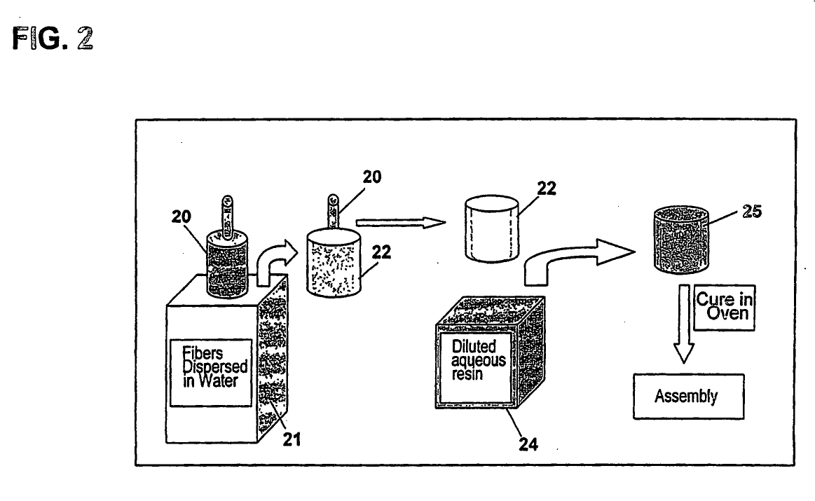

In general, a saturation-type process is shown in FIG. 2. A mandrel 20 is shown immersed in an aqueous system 21 having fibers dispersed therein. A vacuum drawn from the interior of the mandrel generates a mandrel 20 having a fiber matrix 22 thereon (a vacuum formed fiber matrix). The fiber matrix 22 can be removed from the mandrel and then be immersed in or soaked in the diluted aqueous resin system 24, which results in a resin loaded matrix 25. (The resin loaded matrix 25 can alternately be done while the matrix is still on the mandrel.) Upon cure, a three dimensional fiber matrix, usable in an assembly process to generate a coalescer stage or drain stage, results.

Another method of introducing water-based binders into the media is through a beater addition process. The term “beater addition process” refers to a process used in the papermaking industry to describe the addition of resin or additives during the slurry preparation process. (In papermaking, a beater is used to help disperse the fibers by mechanically breaking up the larger clumps. For this project, resin is added to the glass fiber slurry.) Here, after glass fibers have been dispersed in water, water based resin is added into the system. Flocculant (sometimes referenced as binding agent) is added to make resin particles attach to the fibers. When the air/oil separation medium is vacuum formed, the resin particles are retained within it. Water evaporates as the medium is heated to cure the resin.

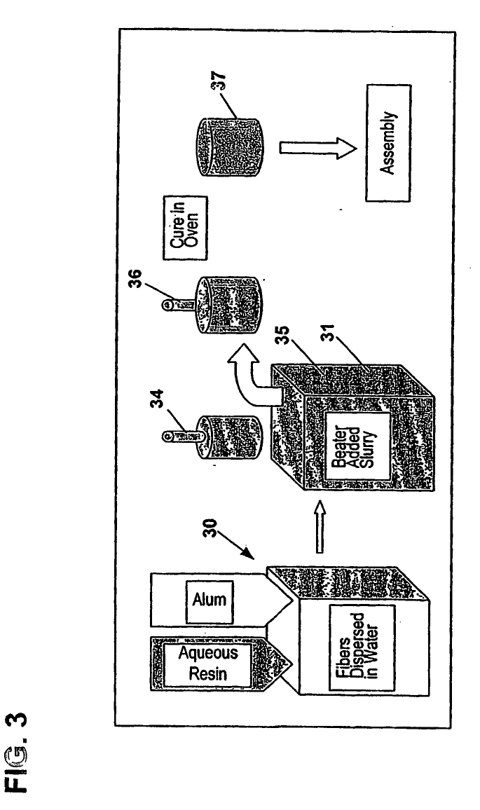

In FIG. 3, a schematic depiction of a beater addition process in shown. In a first stage 30, a dispersion of fibers, aqueous resin and alum is prepared. In a second stage 31, mandrel 34 is inserted into slurry 35. A vacuum draw in the mandrel will load the fibers from the slurry onto the mandrel, to create a fiber loaded mandrel 36. The fiber construction 36 can be cured, to form a resin loaded fiber matrix 37, which then can be used to generate a coalescer stage or drain stage, in an air/oil separator or similar construction.

Initial experimentation was concentrated on saturating air/oil separation media using various water based binders. A difficulty encountered with saturation using water based binders was that the resin particles move to the surface of the medium as water evaporates. Migration of the resin is not desirable because the end result is the formation of a crust on the surface of the dried medium and absence of strength inside the medium. Migration can be a problem when the separation medium is thick, for example at least 5 mm thick.

In typical applications of the principles described herein, the media will be at least 5 mm thick, often at least 8 mm thick, sometimes at least 12 mm thick, for example in some instances on the order of at least 12.7 mm (one half inch) thick. In some systems the thickness will be no more than 25.4 mm (one inch), and in some no more than 19 mm (0.75 inch) thick, although alternatives are possible.

In more general terms, the present application provides techniques to control migration of resin in a media pack when an aqueous based binder is used, in systems wherein without techniques such as those described herein, migration of the resin could be a problem. This would be in a system that is relatively thick by comparison to sheet media, which is typically under 2 mm thick.

The binder resin gives the medium the required strength to withstand a typical compressed air application. Items having an absence of resin inside the medium are known to have decreased performance properties. In some cases the medium is damaged by the compressed air.

A dark red dye was used to visually keep track of resin penetration in the medium. Through experimentation, it was found that the dye colors the resin particles but not the fibers. The glass fiber medium was vacuum formed and then dipped in a diluted water based binder. Dye was mixed with the diluted binder to provide a visual trace of the resin. Because of the resin migration behavior, the heat cured media had dark red crusted surfaces and colorless inside sections. Several steps done to attempt to slow down water evaporation did not prevent resin migration.

Focus of the experimentation shifted to the beater addition method. In this process, the binder was diluted in the fiber slurry. The binder was added to the glass fibers after the fibers were dispersed in water. Aluminum sulfate (alum) was used as a binding agent (or flocculant or surfactant) to precipitate the binder particles onto the glass fibers. When the medium was vacuum formed, the binder particles became part of it automatically. The resulting medium was then heat cured. Because of the bonds between the resin molecules and the surfactant, the surfactant and the aluminum ion, and the aluminum ion and the fibers, binder migration is eliminated. That is, the inorganic agent (preferably alum) helps bind the resin throughout the fiber matrix.

In laboratory experiments, beater added slurry was used to form discs, which were then sliced open after heat cure. Dark red color inside the discs indicated the presence of the binder. The original color of the binder mixture was milky white; it turned dark red when dye was added. After the addition of alum, the binder particles begin to attach themselves to the fibers. When all the binder particles are attached to the fibers, the slurry loses its milky appearance, and the liquid becomes clear. Depending on the type of binder used, it might be necessary to add a crosslinker into the slurry. Cymel 303 from Cytec was used as an additional crosslinker for PN3697-H from HB Fuller.

Based on these laboratory results, full size air/oil separator samples were built using the beater addition process. Several samples were built; two air/oil separator prototypes were tested in an air compressor. Both samples survived the compressor operating conditions; one sample withstood 50,000 cycles of high-low pressure cycling. The performance characteristics were acceptable, but not as good as production parts built with solvent carried epoxy binder. The difference in oil carryover and pressure drop results between the prototypes and the production parts was not large. The oil carryover results for the prototype averaged 0.14 ppm higher than the standard production part (lower is better). The optimum carryover would be less than 2 ppm for a typical air compressor application, so in this case it was about 7% higher than standard production parts. These results were very encouraging. The pressure drop results were 17% (less than 0.5 psid difference between the prototype and standard parts at 100 psig system pressure) higher than standard production parts. It was agreed that the beater addition concept worked in the air/oil separation media formation process.

B. Ingredients.

Two types of water based organic resins studied. Some resins were dissolved in water, so the resin and the water are in the liquid phase. The other type of samples were latex dispersions where the resin molecules are surrounded by surfactant which keep them from settling. Aluminum sulfate is added into the system so that the aluminum ion works as a bridge between the negatively charged surfactant covering the resin molecules and the negatively charged glass fibers in the slurry.
C. Hypothetical Process.
Equipment for a beater addition process would include:
1. A fiber weighing station;
2. A fiber dispersion tank;
3. A beater addition tank (chest) to supply the forming tank;
4. A media forming tank; and
5. A curing oven.
The equipment used in current solvent based systems includes:
1. A fiber weighing station;
2. A fiber dispersion tank;
3. A holding tank (chest) to supply the forming tank;
4. A media forming tank;
5. A drying oven which is also used for curing; and
6. An explosion proof saturation and evaporation room.
In the beater addition process, glass fibers (typically borosilicate glass) would be dispersed in the dispersion tank and transferred into the beater addition tank. After the addition of binder and alum, the slurry is ready to be used to form media. When the forming process is complete, the media, formed into tubes, would get cured in a curing oven while water evaporates. When curing is complete, the media tubes are ready for assembly. This process would be a batch process where the dispersion tank would feed the beater addition tank, and the beater addition tank would supply the forming tank. The content of the beater addition tank would have to be used up before fiber slurry can be transferred from the dispersion tank to maintain the same fiber-resin ratio.

As an example, the process would begin with an operator weighing 950 grams of 608 fibers and 2850 grams of 610 fibers. These 3800 grams of fibers would then be added to 500 gallons of water adjusted to pH between 2.5 and 3.5. A typical acid used to lower the pH of the water is sulfuric acid. The fibers would be dispersed using a one-horsepower variable speed mixer at full speed for 20 minutes. The slurry would then be sampled to check for fiber dispersion. This visual observation would determine if the fibers were well enough dispersed. The dispersed fiber slurry would then be transferred to a chest tank where resin and alum additions would take place. For 500 gallons of slurry, 1900 grams of undiluted latex resin would be added, and 190 grams of alum powder would be added. This ratio would result in a slurry mixture that would produce media with 20% maximum resin content. The beater addition slurry would preferably be agitated at a controlled pace so the solids do not settle, but not too vigorous that the bonds between the resin and fibers are broken. For any specific system, study would be required to determine optimum conditions for this portion of the process.

It is anticipated that typically, resin would be added first into the slurry followed by alum. The alum powder would be dissolved in water before addition into the slurry. Following the alum addition, the slurry is ready to be used. It would be pumped into a forming tank where a mandrel attached to a vacuum pump at specified settings would be lowered into the slurry and the medium would build up on it. The forming tank would also be agitated at the same rate as the beater addition tank. The formed media tube would then be transferred to an oven at 300° F. for one hour to cure the resin and evaporate the water at the same time. This would complete the media formation process.

For a slurry containing 7.6 grams of fibers (combined weight of both grades of fibers) per gallon of water, the amount of solids from the resin should be within 1.67 grams to 2.02 grams. For each gram of combined fiber weight, between 0.0625 grams of alum (dissolved in 0.5625 grams of water) and 0.25 grams of alum (dissolved in 2.25 grams of water) can be added to the slurry to precipitate the resin on the fibers. The specified amounts will precipitate all of the resin in the mixture, adding more alum will not increase the resin content in the finished medium. The amount of resin specified will produce a separation medium with about 20% resin content, which will add to its durability without decreasing its separation efficiency and without restricting air output beyond the allowed range of 2 psid or less for a typical air/oil separator. Adding more resin will increase the restriction across the medium beyond the specified 2-psid limit.

Resin PN3697-H from HB Fuller required heat to speed up the fiber-alum-resin bond. Resins HB Fuller PD2085-A2, Noveon Hycar 1570X75, and BASF Acronal 2348 did not require heat or extra time for resin-alum-fiber bond. Resin-alum-fiber bonds have formed when the mixture has gone from milky to clear.

D. Materials and Suppliers.

The preferred glass fibers used are grades 608 (0.8 micron diameter) and 610 (2.6 micron diameter) from Evanite. Thus, the typical, preferred, glass fibers have diameters less than 4 microns. The identified fibers are multipurpose borosilicate glass fibers with a typical length of less than 5 millimeters. The preferred binder resin can be either PD2085-A2 from HB Fuller, or Hycarl 570X75 from Noveon, or Acronal 2348 from BASF. PD2085-A2 from HB Fuller is an acrylic-urethane hybrid latex. Hycar 1570X75 from Noveon is a carboxy-modified ABS (acrylonitrile-styrene-butadiene) latex. Acronal 2348 from BASF is a solution of substituted polycarboxilic acid with a polybasic alcohol crosslinker. PN3697-H from HB Fuller is an acrylic emulsion in water. Cymel 303 from Cytec is a melamine crosslinker. Alum used in this project (aluminum sulfate powder) was purchased from Fisher Scientific catalog. Aluminum sulfate is commercially available; it is also known as papermaking alum. There are alternatives to alum powder, which include many types of flocculant (papermaking literatures mention starches and ferric compounds), but alum is typically preferred because it has been widely used in the papermaking industry and is well understood. The resin candidates are commercially available products.

HB Fuller is located at 1200 Willow Lake Boulevard, St. Paul, Minn. 55164-0683. Noveon, Incorporated is located at 9911 Brecksville Road, Cleveland, Ohio 44141-3247. Cytec Industries, Incorporated is located at Five Garrett Mountain Plaza, West Paterson, N.J. 07424. Fisher Scientific is located at 3970 Johns Creek Court Suite 500, Suwanee, Ga. 30024.

E. Applications.

The main application for media made with this process would be for air/oil separators used in an air compressor. In an oil flooded rotary screw air compressor, the compressed air is laden with oil mist. The air/oil separator removes oil from the air stream before the compressed air is released into the service line supplying the end user. Air leaving the air/oil separator would typically have an oil content of 2 parts per million (ppm) by weight. The typical operating conditions endured by an air/oil separator are temperatures of 170° F.-225° F. (76.7-107.2° C.) and air at a pressure range of 60 to 190 psig (4.1- 13.1 Bar). The performance specifications for the air/oil separator are 2 ppm oil content leaving the separator and a starting pressure drop of less than 2 psid (0.138 Bar).

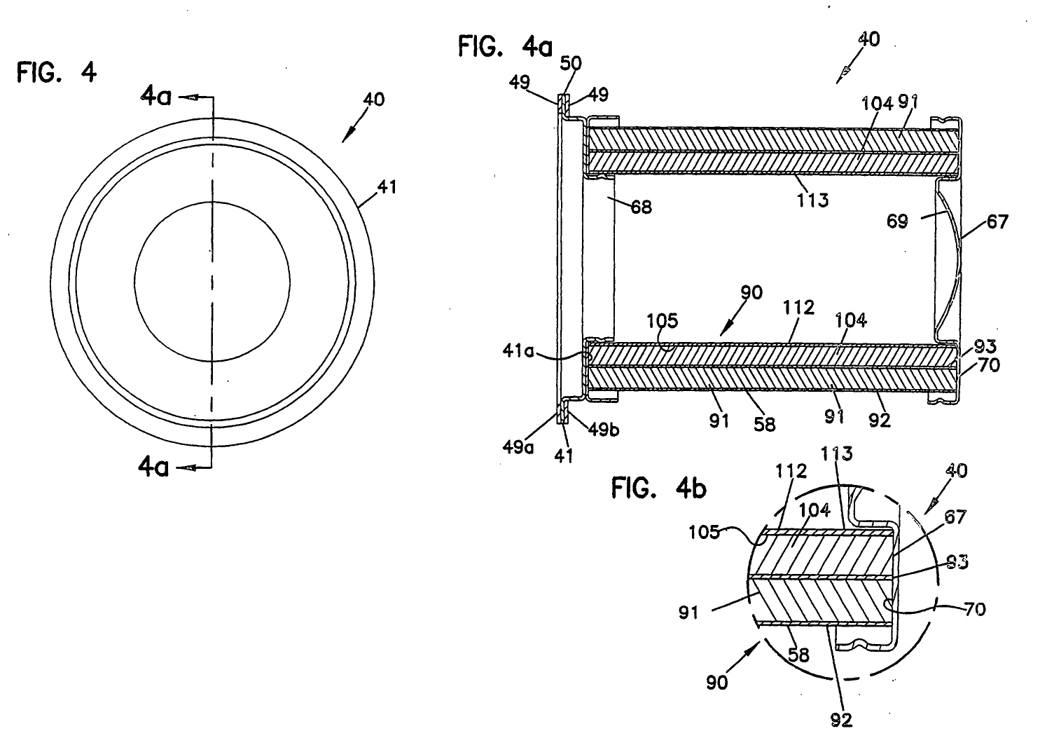

A typical air/oil separator 40 is illustrated in the included Donaldson drawings for a Donaldson part number designated as FIGS. 4, 4a and 4b. The separator 40 hangs inside a compressed air vessel with flange 41 is clamped down by the vessel lid. Compressed air passes through the separator 40 to the service line. The separator 40 removes oil mist from the air stream. For the separator 40 of the drawings, air passes from outside to inside, although alternatives are possible. That is, this resin application process is used for media made for inside-out-flow separators as well as outside-in-flow separators.

Parts that make up the separator 40 in the figures are described in the following paragraphs.

Referring to FIG. 4a, gaskets 49 are shown. Two gaskets 49 are typically attached to a separator flange 50, on opposite sides. The flange 50 can be metal or plastic molded directly to the media; a metal one is shown. These gaskets 49 seal to the receiver tank when the separator 40 is installed. The top gasket 49a seals between the receiver lid and the separator flange 41. The bottom gasket 49b seals between the lip of the receiver, where the separator 40 hangs, and the separator flange 41. The gaskets 49 can be made out of any of numerous materials, including, for example, like rubbers, corks, silicone, and elastomeric compounds like polyurethane and epoxies.

Referring to FIG. 4b, an optional outer logo wrap at 58 can be used. The optional outer logo wrap at 58 is typically a high permeability material printed with the customer logo. It can be made of polyester or other polymeric materials or treated cardboard.

In FIGS. 4a and 4b, an end cap 67 is shown. The end cap 67 functions as a plug so air would only escape from then flange 41 exit hole 68. It also provides a reservoir 69 for coalesced oil to collect and be scavenged out by the compressor's oil return arrangement. The end cap 67 has a sealant well 70 where elastomeric material, like polyurethane or epoxy, is poured in to seal the coalescing and drain stage media tubes. The end cap 67 can be metal or plastic molded directly to the media. A metal one is shown.

In FIGS. 4 and 4a, a flange assembly 41 is shown. The flange assembly 41 contains a sealant well 41a where elastomeric material, like polyurethane or epoxy, is poured in to seal the coalescing and drain stage media tubes, when the flange 41 is not molded directly to the media.

In FIGS. 4a and 4b, a media assembly 90 is shown. The media assembly 90 includes a coalescing stage 91 for this air/oil separator 40. The example shown includes an optional outer liner 92, glass fiber medium 91, and perforated metal media support tube 93. The outer liner 92 shown is expanded metal, but alternatives could be used. The liner 92 is there to provide a uniform surface for the outer logo wrap to wrap over. The glass medium 91 functions as a separation medium where oil droplets get collected and provides surface to coalesce and grow in volume. It can be a medium prepared according to the above description. The perforated support tube (center liner) provides structural support to the glass medium.

In FIGS. 4a and 4b a media layer 104 is shown. This medium 104 is the main drainage medium in the separator. The medium removes larger oil droplets leaving the coalescing stage 91 and drains them into the scavenge reservoir 69 in the end cap 67. It can be made of non-woven polyester material, metal fibers, metal fibers flocculated with glass or other polymeric material, or bonded glass fibers. It can be a medium prepared according to the above descriptions.

In FIGS. 4a and 4b a media layer at 105 can be used. This medium is used as a scrim to catch any re-entrained oil droplets escaping the drainage medium 104. It is preferably made of typically a spunbond polyester material.

In FIGS. 4a and 4b a screen at 112 can be used. The screen at 112 would be made of aluminum would be placed in the assembly per customer specification. It has no function of separating oil droplets from air.

In FIGS. 4a and 4b an inner liner 113 is shown. The inner liner 113 is made of an expanded metal tube, but a plastic one could be used. It is the support tube for the drainage medium.

For a typical, example, system the length of the separator 40 would be about 247.6±3 mm; the outside diameter of the flange 41 would be about 200.2 mm; the outside diameter for the end cap 67 would be about 174.8 mm; the inside diameter of aperture 68 would be about 96.8 mm; region 41b of flange 41 would have an inside diameter of about 169.9 mm and a height of about 14.2 mm; and the media 90 having length of about 228.6 mm. The metal flange 41 would have a thickness of about 1.63 mm and each gasket would be about 1.5 mm thick.

A wide variety of alternative constructions, to those described in the figures, can be used. The figures simply indicate typical component parts for a separator assembly, in particular an out-to-in flow separator assembly, arranged in a fashion that can utilize media constructed in accord with the present disclosure. Alternate shapes, to the cylindrical one shown, can be used.

There are two main separation media in the separator; the oil is coalesced in the coalescing stage and is gravity-drained from the air stream in the drain stage. Media made with the current disclosed process and components can be used for either or both of these two stages. Compressed air passes through the coalescing stage, and the oil aerosol coalesces to form much larger droplets. The larger droplets further coalesce in the drain stage and become too large to remain airborne; they remain on the drain stage medium while clean air exits the separator. The drawings show a coalescing stage at 105. It contains a support tube 113 made of perforated metal, coalescing medium, and outer liner made of expanded metal. This is a typical air/oil separator application inside an air compressor.

The coalescing medium can also be used in other applications to separate oil mist from air. It can be used as a filter for further refining the air quality downstream of the air compressor; this application being referred to as “in-line coalescer” or “point of use coalescer” or after treatment of compressed air line. They are also separators, but are sometimes called coalescers. These coalescers are connected to the service line downstream of an air compressor. The function of these coalescers is to further reduce the oil content in the compressed air line. After compressed air leaves the air/oil separator in the compressor, it enters a heat exchanger where it gets cooled. The compressed air leaving the heat exchanger would then pass through the in-line coalescers, moisture removal system, and then out into the end user service line. As in-line coalescers, the media would function the same way as in an air/oil separator. The media would separate oil mist from air at a lower temperature (typically 160° F. or lower, i.e., 71.1° C. or lower) and with less upstream challenge. The upstream challenge at this point would be 2 ppm or less, whereas in the compressor air/oil separator, the upstream challenge can be several thousand ppm. These in-line coalescers have their own housings; the air/oil separator is typically housed in a receiver tank on the air compressor. Some air/oil separators are spin-on types so they are housed in cans that get threaded onto heads on the air compressor piping. The other difference between the in-line coalescers and other separators is how oil removed from the air line is transported. In air/oil separators like FIG. 4a, the separated oil is piped back into the oil circulation line. For in-line coalescers the coalesced oil is such a low volume that it usually gets discarded; there is no oil return line into the air compressor.

In general, according to the present disclosure, a media matrix for an air/oil separator (in-line coalescer; in compressor system separator or otherwise) is provided. The media matrix generally comprises a glass fiber matrix including an aqueous based resin system and binding agent. The binding agent is preferably an inorganic binding agent, which facilitates binding the resin system to the glass fibers. The term “aqueous based resin system” as used herein, is meant to refer to a resin system that is loaded into the glass fibers, from an aqueous as opposed to an organic solvent based arrangement. The aqueous based resin system can be provided in the slurry from which the glass fiber matrix is formed, or in a separate slurry to which the glass fiber matrix is subjected after having been formed.

A typical process for preparing glass fiber matrix according to the present disclosure, would involve providing an aqueous base slurry of glass fibers, and then drawing the fibers on to a mandrel, with a vacuum draw.

The preferred binding agent comprises alum. The preferred resins are as identified above.

The processes to prepare preferred media matrixes according to the present disclosure, involve a step of curing the resin, typically by application of heat.

What is claimed is:

1. A process for preparing a separator having at least one glass fiber media stage; the process of including a step of:
(a) including, as a glass fiber media stage in the separator, a glass fiber media stage at least 5 mm thick prepared according to a process of:
(i) preparing an aqueous slurry including glass fibers;
(ii) forming a fiber matrix from the glass fibers in the aqueous slurry;
(iii) providing, from an aqueous system: a resin; and, an inorganic agent to precipitate the resin into the fiber matrix; and,
(iv) curing the resin in the matrix with the inorganic agent present to form a glass fiber matrix with resin distributed therethrough.

2. A process according to claim 1 wherein:
(a) the glass fiber media stage is at least 8 mm thick.

3. A process according to claim 1 wherein:
(a) the glass fiber media stage is at least 12 mm thick.

4. A process according to claim 1 wherein:
(a) the glass fiber media stage is at least 12.7 mm thick; and
(b) the step of providing an inorganic agent comprises providing alum.

5. A process according to claim 1 wherein:
(a) the steps of: preparing an aqueous slurry including glass fibers; forming a fiber matrix; and, providing, from an aqueous system, a resin and inorganic agent into the fiber matrix, together comprise:
(i) providing the inorganic agent, resin and glass fibers in an aqueous slurry; and,
(ii) loading the fibers, resin and inorganic agent from the slurry onto a mandrel, by applying a vacuum draw to the mandrel, to form a fiber construction; with resin distributed therein.

6. A process according to claim 5 wherein:
(a) the step of providing the inorganic agent, resin and glass fibers in a slurry comprises providing glass fibers having lengths of less than 5 mm.

7. A process according to claim 6 wherein:
(a) the step of providing the inorganic agent, resin and glass fibers in a slurry comprises providing borosilicate glass fibers.

8. A process according to claim 7 wherein:
(a) the step of providing the inorganic agent, resin and glass fibers in a slurry comprises providing, as the inorganic agent, alum.

9. A process according to claim 8 wherein:
(a) the step of providing the inorganic agent, resin and glass fibers in a matrix comprises providing, as the resin, a latex resin.

10. A process according to claim 9 wherein:
(a) the resin is selected from the group consisting essentially of: acrylic-urethane hybrid latex and carboxy-modified acrylonitrile-styrene-butadiene latex.

11. A process according to claim 8 wherein:
(a) the resin is selected from the group consisting essentially of: acrylic-urethane hybrid latex; carboxy-modified acrylonitrile-styrene-butadiene latex; and, a solution of substituted polycarboxylic acid with a polybasic alcohol cross linker.

12. A process according to claim 9 wherein:
(a) the step of providing the inorganic agent, resin and glass fibers in an aqueous slurry comprises:
(i) adding glass fibers to an aqueous system and dispersing the fibers with a mixer to form a dispersed fiber slurry;
(ii) adding the resin and inorganic agent to the dispersed fiber slurry.

13. A process according to claim 12 wherein:
(a) the step of adding the resin and inorganic agent to the dispersed fiber slurry comprises providing a resin content such as to provide a resulting matrix with a resin content of no greater than 20%.

14. A separator including at least one glass fiber media stage made in accord with a process of claim 1.

15. A separator having at least one glass fiber media stage; the at least one glass fiber media stage comprising:
(a) a formed media tube having media at least 5 mm thick comprising: glass fiber media; resin and inorganic agent formed from an aqueous dispersion including the glass fiber media, resin and inorganic agent.

16. A separator according to claim 15 wherein:
(a) the glass fiber media stage is at least 8 mm thick.

17. A separator according to claim 15 wherein:
(a) the glass fiber media stage is at least 12 mm thick.

18. A separator according to claim 15 wherein:
(a) the glass fiber media stage is at least 12.7 mm thick; and
(b) the step of providing an inorganic agent comprises providing alum.

19. A separator according to claim 15 wherein:
(a) the separator is an air/oil separator; and
(b) the at least one glass fiber media stage comprises a coalescing stage.

20. A separator according to claim 19 including:
(a) a drain stage;
(b) the coalescing stage and drain stage being secured to a separator flange.

21. A process for preparing a separator having at least one glass fiber media stage, the process including a step of:
(a) including, as a glass fiber media stage in the separator, a glass fiber media stage having a thickness of at least 5 mm and made according to a process of:
(i) preparing an aqueous slurry including glass fibers and resin; the resin being in an amount to provide a resin solids content within the range of 1.67 g to 2.02 g per gallon of water; and,
(ii) forming a fiber matrix having resin therein from the glass fibers in the slurry.

22. A process according to claim 21 wherein:
(a) the glass fiber media stage is provided at least 8 mm thick.

23. A process according to claim 21 wherein:
(a) the glass fiber media stage is provided at least 12 mm thick.

24. A process according to claim 21 wherein:
(a) the glass fiber media stage is provided at least 12.7 mm thick; and
(b) the step of providing an inorganic agent comprises providing alum.

25. A process according to claim 21 wherein:
(a) the slurry contains 7.6 grams of fibers per gallon of water;
(b) the slurry contains between 0.0625 g and 0.25 g of alum, per gram of fiber; and
(c) the slurry includes a resin content sufficient to provide 20% resin content in the fiber matrix.

26. A separator made according to the process of claim 25.
